(19) United States
(12) Patent Application Publication
(10) Pub. No.: US 2025/0300418 A1
(43) Pub. Date: Sep. 25, 2025

(54) DISCHARGE CHAMBER FOR GAS LASER APPARATUS AND ELECTRONIC DEVICE MANUFACTURING METHOD

(71) Applicant: Gigaphoton Inc., Tochigi (JP)

(72) Inventors: Rei TAKENAKA, Oyama-shi (JP); Junichi FUJIMOTO, Oyama-shi (JP)

(73) Assignee: Gigaphoton Inc., Tochigi (JP)

(21) Appl. No.: 19/226,440

(22) Filed: Jun. 3, 2025

Related U.S. Application Data
(63) Continuation of application No. PCT/JP2023/002744, filed on Jan. 27, 2023.

(51) Int. Cl. H01S 3/036; H01S 3/034

(52) U.S. Cl. CPC H01S 3/036; H01S 3/034

(57) ABSTRACT

A discharge chamber for a gas laser apparatus has an internal space in which a pair of discharge electrodes facing each other with a spacing therebetween are disposed and which encapsulates a laser gas. The discharge chamber includes a first chamber part and a second chamber part combined with each other to enclose at least a portion of the internal space, and a metal seal including a straight section and a curved section, disposed between the first chamber part and the second chamber part, and pressed by the first chamber part and the second chamber part to seal a gap between the first chamber part and the second chamber part. The curved section of the metal seal, when assumed to be made straight, has a spring constant in a pressing direction smaller than a spring constant of the straight section of the metal seal in the pressing direction.

### CROSS-REFERENCE TO RELATED APPLICATIONS

The present application is a continuation application of International Application No. PCT/JP2023/002744, filed on Jan. 27, 2023, the entire contents of which are hereby incorporated by reference.

### BACKGROUND

### 1. Technical Field

The present disclosure relates to a discharge chamber for a gas laser apparatus and an electronic device manufacturing method.

### 2. Related Art

In recent years, a semiconductor exposure apparatus is required to improve the resolution thereof as semiconductor integrated circuits are increasingly miniaturized and highly integrated. To this end, reduction in the wavelength of light emitted from a light source for exposure is underway. For example, a KrF excimer laser apparatus, which outputs laser light having a wavelength of about 248 nm, and an ArF excimer laser apparatus, which outputs laser light having a wavelength of about 193 nm, are used as a gas laser apparatus for exposure.

The light from spontaneously oscillating KrF and ArF excimer laser apparatuses has a wide spectral linewidth ranging from 350 μm to 400 pm. A projection lens made of a material that transmits ultraviolet light, such as KrF and ArF laser light, therefore produces chromatic aberrations in some cases. As a result, the resolution of the projection lens may decrease. To avoid the decrease in the resolution, the spectral linewidth of the laser light output from the gas laser apparatus needs to be narrow enough to make the chromatic aberrations negligible. To this end, a line narrowing module (LNM) including a line narrowing element (such as etalon or grating) is provided in some cases in a laser resonator of the gas laser apparatus to narrow the spectral linewidth. A gas laser apparatus providing a narrowed spectral linewidth is hereinafter referred to as a narrowed-line gas laser apparatus.

### CITATION LIST

### Patent Literature

PTL 1:JP-A-2007-141941
PTL 2:JP-A-2016-075307

### SUMMARY

A discharge chamber for a gas laser apparatus according to an aspect of the present disclosure may be a discharge chamber for a gas laser apparatus having an internal space in which a pair of discharge electrodes facing each other with a spacing therebetween are disposed and which encapsulates a laser gas. The discharge chamber includes a first chamber part, a second chamber part, and a metal seal. The first chamber part and the second chamber part are combined with each other to enclose at least a portion of the internal space. The metal seal includes a straight section and a curved section. The metal seal is disposed between the first chamber part and the second chamber part. The metal seal is pressed by the first chamber part and the second chamber part to seal a gap between the first chamber part and the second chamber part. The curved section of the metal seal, when assumed to be made straight, has a spring constant in a pressing direction smaller than a spring constant of the straight section of the metal seal in the pressing direction.

An electronic device manufacturing method according to another aspect of the present disclosure may include generating laser light by using a gas laser apparatus including a discharge chamber; outputting the laser light to an exposure apparatus; and exposing a photosensitive substrate to the laser light in the exposure apparatus to manufacture electronic devices. The discharge chamber has an internal space in which a pair of discharge electrodes facing each other with a spacing therebetween are disposed and which encapsulates a laser gas. The discharge chamber includes a first chamber part, a second chamber part, and a metal seal. The first chamber part and the second chamber part are combined with each other to enclose at least a portion of the internal space. The metal seal includes a straight section and a curved section. The metal seal is disposed between the first chamber part and the second chamber part. The metal seal is pressed by the first chamber part and the second chamber part to seal a gap between the first chamber part and the second chamber part. The curved section of the metal seal, when assumed to be made straight, has a spring constant in a pressing direction smaller than a spring constant of the straight section of the metal seal in the pressing direction.

### BRIEF DESCRIPTION OF DRAWINGS

Some embodiments of the present disclosure will be described below only by way of example with reference to the accompanying drawings.

FIG. 1 is a diagrammatic view showing a schematic configuration example of an entire electronic device manufacturing apparatus.

FIG. 2 is a diagrammatic view showing a schematic configuration example of an entire gas laser apparatus according to Comparative Example.

FIG. 3 is a cross-sectional view of a chamber apparatus according to Comparative Example taken along a plane perpendicular to a laser light traveling direction.

FIG. 4 is a top view of a lower chamber.

FIG. 5 is a top view of an upper chamber.

FIG. 6 shows a cross section of a metal seal perpendicular to a longitudinal direction thereof.

FIG. 7 shows a cross section of the metal seal taken along the longitudinal direction thereof.

FIG. 8 is a cross-sectional view of a metal seal used in a discharge chamber for a gas laser apparatus according to a first embodiment taken along the longitudinal direction of the metal seal.

FIG. 9 is a cross-sectional view of a metal seal in a first variation taken along the longitudinal direction.

FIG. 10 is a cross-sectional view of a metal seal in a second variation taken along the longitudinal direction.

FIG. 11 is a cross-sectional view of a metal seal in a third variation taken along the longitudinal direction.

FIG. 12 is a cross-sectional view of a metal seal used in a discharge chamber for a gas laser apparatus according to a second embodiment taken along the longitudinal direction of the metal seal.

FIG. 13 shows another variation of the metal seal.

### DETAILED DESCRIPTION

1. Description of electronic device manufacturing apparatus used in electronic device exposure step
2. Description of Comparative Example
2.1 Configuration
2.2 Operation
2.3 Problems
3. Description of first embodiment
3.1 Configuration
3.2 Effects and advantages
4. Description of second embodiment
4.1 Configuration
4.2 Effects and advantages

Embodiments of the present disclosure will be described below in detail with reference to the drawings. The embodiments described below show some examples of the present disclosure and are not intended to limit the contents of the present disclosure. Furthermore, all configurations and operations described in the embodiments are not necessarily essential as configurations and operations in the present disclosure. Note that the same element has the same reference character, and that no redundant description of the same element will be made.

### 1. Description of Electronic Device Manufacturing Apparatus Used in Electronic Device Exposure Step

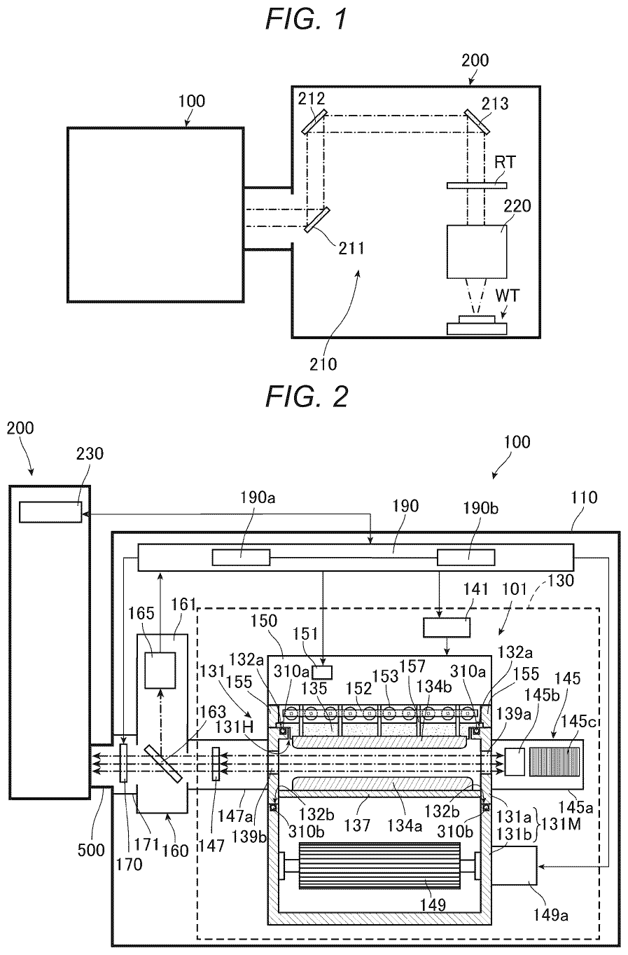

FIG. 1 is a diagrammatic view showing a schematic configuration example of an entire electronic device manufacturing apparatus used in an electronic device exposure step. The manufacturing apparatus used in the exposure step includes a gas laser apparatus 100 and an exposure apparatus 200, as shown in FIG. 1. The exposure apparatus 200 includes an illumination optical system 210, which includes multiple mirrors 211, 212, and 213, and a projection optical system 220. The illumination optical system 210 illuminates a reticle pattern on a reticle stage RT with laser light incident thereon from the gas laser apparatus 100. The projection optical system 220 performs reduction projection on the laser light having passed through the reticle to bring the laser light into focus on a workpiece that is not shown but is placed on a workpiece table WT. The workpiece is a photosensitive substrate, such as a semiconductor wafer onto which a photoresist has been applied. The exposure apparatus 200 translates the reticle stage RT and the workpiece table WT in synchronization with each other to expose the workpiece to the laser light having reflected the reticle pattern. Semiconductor devices that are electronic devices can be manufactured by transferring a device pattern onto the semiconductor wafer in the exposure step described above.

### 2. Description of Comparative Example

### 2.1 Configuration

The gas laser apparatus 100 according to Comparative Example will be described. Note that Comparative Example in the present disclosure is a form that the applicant is aware of as known only by the applicant, and is not a publicly known example that the applicant is self-aware of.

FIG. 2 is a diagrammatic view showing a schematic configuration example of the entire gas laser apparatus 100 according to Comparative Example. The gas laser apparatus 100 is an ArF excimer laser apparatus using a mixture gas containing, for example, argon (Ar), fluorine (F₂), and neon (Ne). The gas laser apparatus 100 outputs laser light having a center wavelength of about 193 nm. Note that the gas laser apparatus 100 may instead be a gas laser apparatus other than the ArF excimer laser apparatus, for example, a KrF excimer laser apparatus using a mixture gas containing krypton (Kr), F₂, and Ne. In this case, the gas laser apparatus 100 outputs laser light having a center wavelength of about 248 nm. The mixture gas containing Ar, F₂, and Ne, which are laser media, and the mixture gas containing Kr, F₂, and Ne, which are laser media, are each called a laser gas in some cases.

The gas laser apparatus 100 includes as primary elements an enclosure 110, a laser oscillator 130, a monitor module 160, a shutter 170, and a laser processor 190, the latter four of which are disposed in the internal space of the enclosure 110, as shown in FIG. 2. FIG. 2 shows the internal configuration of a chamber apparatus 101 in a cross-sectional view taken along a plane containing the traveling direction of the laser light. In the following description, the left side of the plane of view along the laser light traveling direction may be referred to as a front side, the right side as a rear side, the upper side as an upper side, and the lower side as a lower side.

The laser oscillator 130 includes the chamber apparatus 101, a charger 141, a line narrowing module 145, an output coupling mirror 147, and a pulse compression circuit 150 as primary elements.

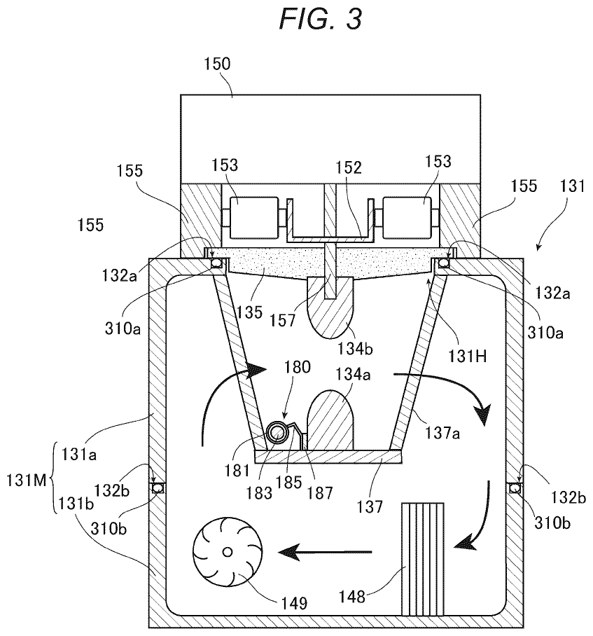

FIG. 3 is a cross-sectional view of the chamber apparatus 101 taken along a plane perpendicular to the laser light traveling direction. The chamber apparatus 101 includes a discharge chamber 131, and the discharge chamber 131 encloses an internal space where the laser medium in the laser gas is excited by discharge that will be described later to generate light. The discharge chamber 131 is a discharge chamber for a gas laser apparatus. The discharge chamber 131 of the chamber apparatus 101 in the present example includes a chamber body 131M, which is divided into an upper chamber 131a and a lower chamber 131b, and an electrically insulating plate 135 serving as a lid, as shown in FIGS. 2 and 3. The upper chamber 131a is a member having an upper surface through which an opening 131H is formed, and constitutes at least a portion of the upper side of the discharge chamber 131. The lower chamber 131b is a bottomed member and constitutes at least a portion of the lower side of the discharge chamber 131. The upper chamber 131a and the lower chamber 131b are combined with each other with the lower edge of the upper chamber 131a and the upper edge of the lower chamber 131b facing each other. The upper chamber 131a and the lower chamber 131b are thus combined with each other so that the upper chamber 131a and the lower chamber 131b enclose at least a portion of the internal space of the discharge chamber 131. Examples of the material of the upper chamber 131a and the lower chamber 131b may include metal such as nickel-plated aluminum and nickel-plated stainless steel.

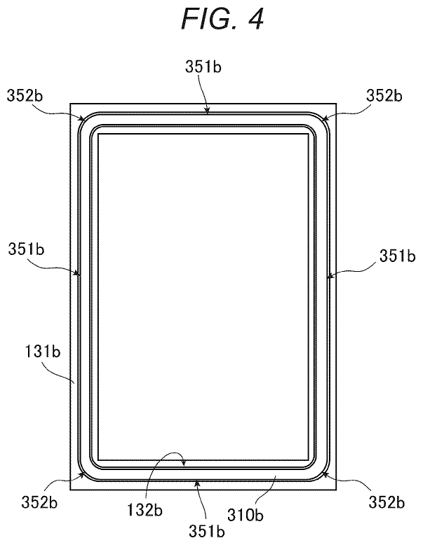

FIG. 4 is a top view of the lower chamber 131b. The internal space of the discharge chamber 131 taken along a horizontal plane has a substantially quadrangular cross-sectional shape, as shown in FIG. 4. That is, the upper edge of the lower chamber 131b surrounds a substantially quadrangular opening. A groove 132b is formed at the upper edge of the lower chamber 131b, and a metal seal 310b is disposed in the groove 132b. The metal seal 310b therefore also has a substantially quadrangular shape and includes straight sections 351b and curved sections 352b. In the present example, the metal seal 310b has a substantially rectangular shape. The length of each of the straight sections 351b, which are the long sides of the rectangular shape, is, for example, approximately 800 mm, and the length of each of the straight sections 351b, which are the short sides of the rectangular shape, is, for example, approximately 300 mm. The length of each of the curved sections 352b is, for example, approximately 50 mm. The upper chamber 131a and the lower chamber 131b are fixed to each other with the two chambers pressed against each other by a member that is not shown. The metal seal 310b is deformed by the pressing force so as to collapse in the pressing direction to seal a gap between the upper chamber 131a and the lower chamber 131b. Assuming that the upper chamber 131a and the lower chamber 131b are called a first chamber part and a second chamber part, respectively, the first chamber part and the second chamber part are combined with each other to enclose at least a portion of the internal space of the discharge chamber 131, and the metal seal 310b seals the gap between the first chamber part and the second chamber part. The metal seal 310b will be described later in detail.

The laser gas in the internal space of the discharge chamber 131 is supplied from a laser gas supply source that is not shown via a pipe that is not shown. The laser gas in the discharge chamber 131 is caused to flow through a halogen filter that removes the F₂ gas from the laser gas or otherwise treated, and the removed F₂ gas is exhausted by an exhaust pump that is not shown into the enclosure 110 through a pipe that is not shown.

The opening 131H of the upper chamber 131a of the chamber body 131M is closed with the electrically insulating plate 135. The chamber body 131M and the electrically insulating plate 135 are thus combined with each other to enclose at least a portion of the internal space of the discharge chamber 131.

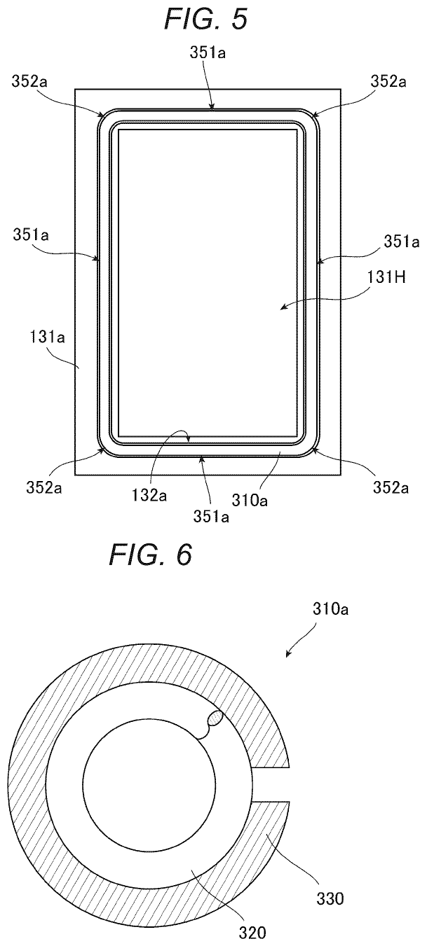

FIG. 5 is a top view of the upper chamber 131a. The opening 131H has a generally quadrangular shape. A groove 132a, which surrounds the opening 131H, is formed in the upper surface of the upper chamber 131a, and a metal seal 310a is disposed in the groove 132a. The metal seal 310a therefore also has a substantially quadrangular shape and includes straight sections 351a and curved sections 352a. In the present example, the metal seal 310a has a substantially rectangular shape. The length of each of the straight sections 351a, which are the long sides of the rectangular shape, is, for example, approximately 780 mm, and the length of each of the straight sections 351a, which are the short sides of the rectangular shape, is, for example, approximately 300 mm. The length of each of the curved sections 352a is, for example, approximately 80 mm. The chamber body 131M and the electrically insulating plate 135 are fixed to each other with the two elements pressed against each other by a member that is not shown. The metal seal 310a is deformed by the pressing force so as to collapse in the pressing direction to seal a gap between the chamber body 131M and the electrically insulating plate 135. Assuming that the chamber body 131M and the electrically insulating plate 135 are called a first chamber part and a second chamber part, respectively, the first chamber part and the second chamber part are combined with each other to enclose at least a portion of the internal space of the discharge chamber 131, and the metal seal 310a seals the gap between the first chamber part and the second chamber part. The metal seal 310a will be described later in detail.

The electrically insulating plate 135 contains an insulator. The electrically insulating plate 135 may be made, for example, of an alumina ceramic material, which has low reactivity with F₂ gas. Note that the electrically insulating plate 135 only needs to be electrically insulating, and examples of the material of the electrically insulating plate 135 may include resin such as phenol resin and fluororesin, quartz, and glass.

In the internal space of the discharge chamber 131, an electrode 134a, which is a first discharge electrode, and an electrode 134b, which is a second discharge electrode, are so disposed that the two electrodes face each other with a spacing therebetween, and that the longitudinal direction of each of the electrodes extends along a predetermined direction that is the laser light traveling direction. In the present example, the electrode 134b is located directly above the electrode 134a. The electrodes 134a and 134b are discharge electrodes that produce glow discharge to excite the laser medium. In the present example, the electrode 134a is the anode, and the electrode 134b is the cathode.

An electrode holder 137 is electrically connected to the chamber body 131M via wiring 137a. The electrode 134a is supported by the electrode holder 137 and electrically connected thereto. The electrode 134a is electrically connected to the ground via the electrode holder 137, the wiring 137a, and the chamber body 131M. The electrode 134b is fixed via a current introducing terminal 157, which is, for example, a bolt, to a surface of the electrically insulating plate 135 that is the surface facing the internal space of the discharge chamber 131. The current introducing terminal 157 is electrically connected to the pulse compression circuit 150, which will be described later, and other circuit parts, and ensures electrical continuity between the pulse compression circuit 150 and the electrode 134b.

The charger 141 is a high-voltage DC power supply that supplies the pulse compression circuit 150 with electric energy. A switch 151 is electrically connected to the charger 141 and controlled by the laser processor 190. When the switch 151 transitions from the off-state to the on-state, the electric energy from the charger 141 is supplied to the pulse compression circuit 150. The pulse compression circuit 150 is disposed on a holder 155, generates a pulse-shaped high voltage from the electric energy stored in the charger 141, and applies the high voltage to the space between the electrodes 134a and 134b.

When the high voltage is applied to the space between the electrodes 134a and 134b, discharge occurs between the electrodes 134a and 134b. The energy of the discharge excites the laser medium in the discharge chamber 131, and the excited laser medium emits light when transitioning to the ground state.

A circuit between the pulse compression circuit 150 and the electrode 134a includes multiple peaking capacitors 153, a connection plate 152, and the current introducing terminal 157 described above as primary elements.

The connection plate 152 is an electrically conductive plate that connects the electrode 134b and the pulse compression circuit 150 to each other, and is configured with a metallic plate having a substantially U-shaped cross section perpendicular to the longitudinal direction of the connection plate 152. One terminal of each of the peaking capacitors 153 is electrically connected to the connection plate 152. The peaking capacitors 153 are each, for example, a ceramic capacitor configured with a dielectric made of strontium titanate. Examples of other materials of the dielectric include barium titanate. The current introducing terminal 157 is electrically connected to the connection plate 152. The one terminal of each of the multiple peaking capacitors 153 is thus electrically connected to the electrode 134b, which is one of the electrodes.

The other terminal of each of the peaking capacitors 153 is electrically connected to the holder 155. The holder 155 is electrically connected to the discharge chamber 131. The other terminal of each of the peaking capacitors 153 is therefore electrically connected to the ground. The other terminal of each of the peaking capacitors 153 is electrically connected to the electrode 134a, which is the other one of the electrodes, via the holder 155.

A preliminary ionization electrode 180 is provided alongside of the electrode 134a on the electrode holder 137. The preliminary ionization electrode 180 includes a dielectric pipe 181, a preliminary ionization inner electrode 183, and a preliminary ionization outer electrode 185.

The dielectric pipe 181 is so disposed that the longitudinal direction thereof coincides with the predetermined direction, and is, for example, a cylindrical pipe. The dielectric pipe 181 is made, for example, of alumina ceramic or sapphire. The preliminary ionization inner electrode 183 is a rod-shaped electrode, is disposed inside the dielectric pipe 181, and extends along the longitudinal direction of the dielectric pipe 181. The preliminary ionization inner electrode 183 is made, for example, of copper or brass. The preliminary ionization outer electrode 185 is disposed between the dielectric pipe 181 and the electrode 134a, and extends along the longitudinal direction of the dielectric pipe 181. An end of the preliminary ionization outer electrode 185 is in contact with the outer circumferential surface of the dielectric pipe 181. Note that when corona discharge, which will be described later, occurs, at least a portion of the end of the preliminary ionization outer electrode 185 does not need to be in contact with the outer circumferential surface of the dielectric pipe 181. The preliminary ionization outer electrode 185 is fixed to a spacer 187, which is fixed to the electrode 134a.

The preliminary ionization inner electrode 183 is electrically connected to the pulse compression circuit 150 via a preliminary ionization capacitor that is not shown. The preliminary ionization outer electrode 185 is electrically connected to the electrode 134a via the electrode holder 137, and also electrically connected to the discharge chamber 131 via the electrode holder 137 and the wiring 137a. The preliminary ionization outer electrode 185 is therefore electrically connected to the ground. When the high voltage is applied to the space between the preliminary ionization inner electrode 183 and the preliminary ionization outer electrode 185 from the pulse compression circuit 150, corona discharge occurs in the vicinity of the end of the preliminary ionization outer electrode 185. The corona discharge assists stable generation of the glow discharge that occurs in the space between the electrodes 134a and 134b.

A crossflow fan 149 and a heat exchanger 148 are disposed at the side opposite to the electrode 134a across the electrode holder 137 in the internal space of the discharge chamber 131. The space of the discharge chamber 131 where the crossflow fan 149 and the heat exchanger 148 are disposed communicates with the space between the electrode 134a and the electrode 134b. The heat exchanger 148 is a radiator that is disposed next to the crossflow fan 149 and connected to a pipe which is not shown but through which a cooling medium flows. The crossflow fan 149 is connected to a motor 149a disposed outside the discharge chamber 131 as shown in FIG. 2, and rotated by the rotation produced by the motor 149a. When the crossflow fan 149 rotates, the laser gas encapsulated in the internal space of the discharge chamber 131 circulates as indicated by the arrows in FIG. 3. At least part of the circulating laser gas passes through the heat exchanger 148, which adjusts the temperature of the laser gas.

The wall surface of the discharge chamber 131 is provided with a pair of windows 139a and 139b. The window 139a is located at one end of the discharge chamber 131 in the laser light traveling direction, and the window 139b is located at the other end in the traveling direction, so that the windows 139a and 139b sandwich the space between the electrodes 134a and 134b. The windows 139a and 139b each incline with respect to the laser light traveling direction by Brewster's angle, so that reflection of the laser light at the windows is suppressed. The oscillating laser light exits out of the discharge chamber 131 via the windows 139a and 139b, as will be described later. Since the pulse compression circuit 150 applies the pulse-shaped high voltage to the space between the electrodes 134a and 134b as described above, the laser light is pulse laser light.

The line narrowing module 145 includes an enclosure 145a, a prism 145b, a grating 145c, and a rotary stage that is not shown, the latter three of which are disposed in the internal space of the enclosure 145a. An opening is formed as a portion of the enclosure 145a, and the enclosure 145a is connected via the opening to the rear side of the discharge chamber 131.

The prism 145b increases the beam width of the light that exits via the window 139a and causes the expanded light to be incident on the grating 145c. Furthermore, the prism 145b reduces the beam width of the light reflected off the grating 145c and causes the resultant light to return into the internal space of the discharge chamber 131 via the window 139a. The prism 145b is supported and rotated by the rotary stage. The rotation of the prism 145b can change the angle of incidence of the light to be incident on the grating 145c to select a wavelength of the light that returns from the grating 145c to the discharge chamber 131 via the prism 145b. FIG. 2 shows an example in which one prism 145b is disposed, and at least one prism only needs to be disposed.

The surface of the grating 145c is made of a high reflectance material, and a large number of grooves are provided at the surface at predetermined intervals. The cross-sectional shape of each of the grooves is, for example, a right triangle. When the light incident from the prism 145b on the grating 145c is reflected off the grooves, the light is diffracted in the direction according to the wavelength of the light. The grating 145c is disposed in the Littrow arrangement, which causes the angle of incidence of the light incident from the prism 145b on the grating 145c to be equal to the angle of diffraction of the diffracted light having a desired wavelength. Light having the desired wavelength and wavelengths therearound thus returns to the discharge chamber 131 via the prism 145b.

The output coupling mirror 147 is disposed in the internal space of an optical path tube 147a connected to the front side of the discharge chamber 131, and faces the window 139b. The output coupling mirror 147 transmits part of the laser light that exits via the window 139b toward the monitor module 160, and reflects the other part of the laser light to cause the light to return into the internal space of the discharge chamber 131 via the window 139b. The grating 145c and the output coupling mirror 147 thus constitute a Fabry-Perot laser resonator.

The monitor module 160 is disposed in the optical path of the laser light output via the output coupling mirror 147. The monitor module 160 includes an enclosure 161, a beam splitter 163, and a photosensor 165, the latter two of which are disposed in the internal space of the enclosure 161. The enclosure 161 is provided with an opening, and the internal space of the enclosure 161 communicates via the opening with the internal space of the optical path tube 147a.

The beam splitter 163 transmits part of the laser light output via the output coupling mirror 147 toward the shutter 170, and reflects the other part of the laser light toward the light receiving surface of the photosensor 165. The photosensor 165 outputs a signal representing energy E of the laser light incident on the light receiving surface to the laser processor 190.

The laser processor 190 in the present disclosure is a processing apparatus including a storage 190a, which stores a control program, and a CPU (central processing unit) 190b, which executes the control program. The laser processor 190 is particularly configured or programmed to carry out various processes described in the present disclosure. The laser processor 190 further controls the entire gas laser apparatus 100.

The laser processor 190 transmits and receives various signals to and from an exposure processor 230 of the exposure apparatus 200. For example, the laser processor 190 receives from the exposure processor 230 signals representing a light emission trigger Tr, which will be described later, and target energy Et, and other pieces of information. The target energy Et is a target value of the energy of the laser light used in the exposure process. The laser processor 190 controls a charging voltage applied to the charger 141 based on the energy E received from the photosensor 165 and the target energy Et received from the exposure processor 230. Controlling the charging voltage controls the energy of the laser light. Furthermore, the laser processor 190 is electrically connected to the shutter 170 and controls the operation of opening and closing the shutter 170.

The laser processor 190 closes the shutter 170 until a difference AE between the energy E received from the monitor module 160 and the target energy Et received from the exposure processor 230 falls within an allowable range. When the difference AE falls within the allowable range, the laser processor 190 transmits a reception preparation completion signal indicating that the laser processor 190 is ready to receive the light emission trigger Tr to the exposure processor 230. Upon reception of the reception preparation completion signal, the exposure processor 230 transmits a signal representing the light emission trigger Tr to the laser processor 190, and upon reception of the signal representing the light emission trigger Tr, the laser processor 190 opens the shutter 170. The light emission trigger Tr is a timing signal or an external trigger, and in response to the light emission trigger Tr, the exposure processor 230 causes the laser oscillator 130 to perform the laser oscillation. The light emission trigger Tr may be specified by a predetermined repetition frequency f of the laser light and a predetermined number of pulses P. The repetition frequency f of the laser light is, for example, higher than or equal to 100 Hz but lower than or equal to 10 kHz.

The shutter 170 is disposed in the optical path of the laser light in the internal space of an optical path tube 171, which communicates with an opening formed at a side of the enclosure 161 of the monitor module 160 that is the side opposite to the side to which the optical path tube 147a is connected. The internal spaces of the optical path tubes 171 and 147a, and the internal spaces of the enclosures 161 and 145a are filled with a purge gas supplied thereto. The purge gas contains an inert gas such as nitrogen (N₂). The purge gas is supplied from a purge gas supply source that is not shown via a pipe that is not shown. The optical path tube 171 communicates with the exposure apparatus 200 through an opening that is a portion of the enclosure 110 and an optical path tube 500, which connects the enclosure 110 and the exposure apparatus 200 to each other. The laser light having passed through the shutter 170 enters the exposure apparatus 200.

The exposure processor 230 in the present disclosure is a processing apparatus including a storage apparatus that stores a control program, and a CPU that executes the control program. The exposure processor 230 is particularly configured or programmed to carry out various processes described in the present disclosure. The exposure processor 230 further controls the entire exposure apparatus 200.

The configurations of the metal seals 310b and 310a in the present example will next be described. In the present example, the metal seals 310b and 310a have substantially the same configurations, so that the metal seal 310a will be described below.

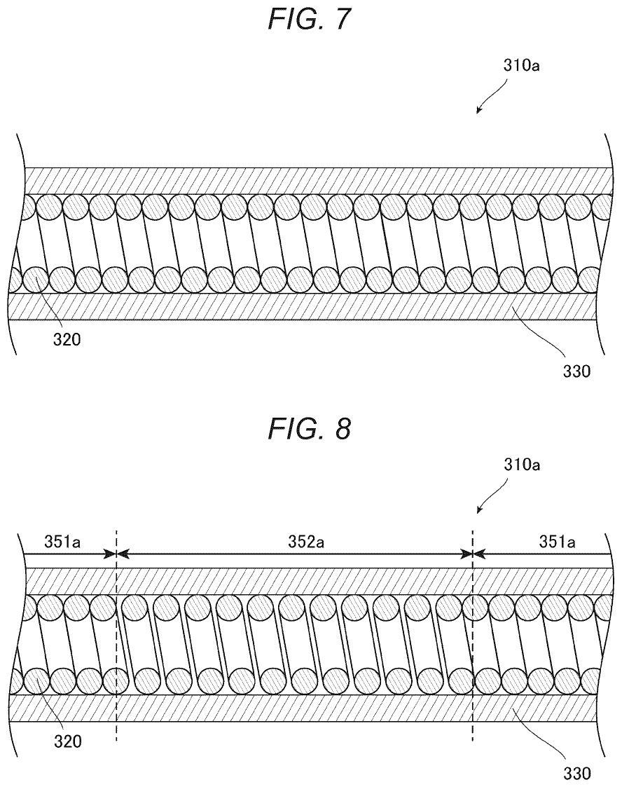

FIG. 6 shows a cross section of the metal seal 310a perpendicular to the longitudinal direction thereof, and FIG. 7 shows a cross section of the metal seal 310a taken along the longitudinal direction thereof. The metal seal 310a in the present example includes a coil spring 320 and an outer shell 330, as shown in FIGS. 6 and 7. The coil spring 320 is configured with a metal wire formed in a spiral shape at a predetermined interval. The outer shell 330 is a member configured with a metal plate-shaped member so processed that the cross-sectional shape thereof perpendicular to the longitudinal direction has a substantially C-like shape. The outer shell 330 substantially surrounds the outer circumferential surface of the coil spring 320.

The metal seal 310a disposed in the groove 132a is pressed in the radial direction by the electrically insulating plate 135 and the chamber body 131M, and deformed so as to collapse in the pressing direction as described above to seal the gap between the chamber body 131M and the electrically insulating plate 135. Similarly, the metal seal 310b disposed in the groove 132b is pressed in the radial direction by the upper chamber 131a and the lower chamber 131b, and deformed so as to collapse in the pressing direction as described above to seal the gap between the upper chamber 131a and the lower chamber 131b.

### 2.2 Operation

The operation of the gas laser apparatus 100 according to Comparative Example will next be described.

In the state before the gas laser apparatus 100 outputs the laser light, the internal spaces of the optical path tubes 147a, 171, and 500 and the internal spaces of the enclosures 145a and 161 are filled with the purge gas from the purge gas supply source, which is not shown. The laser gas is supplied from the laser gas supply source, which is not shown, into the internal space of the discharge chamber 131. When the laser gas is supplied, the laser processor 190 controls the motor 149a to rotate the crossflow fan 149. The rotation of the crossflow fan 149 causes the laser gas to circulate in the internal space of the discharge chamber 131. In this process, the configuration in which the metal seal 310b seals the gap between the upper chamber 131a and the lower chamber 131b and the metal seal 310a seals the gap between the chamber body 131M and the electrically insulating plate 135 prevents the laser gas from leaking out of the discharge chamber 131.

Before the gas laser apparatus 100 outputs the laser light, the laser processor 190 receives the signal representing the target energy Et and the signal representing the light emission trigger Tr from the exposure processor 230. When the laser processor 190 receives the signal representing the target energy Et, the laser processor 190 closes the shutter 170 and drives the charger 141. The laser processor 190 turns on the switch 151 in the pulse compression circuit 150. The current from the charger 141 is thus charged in the peaking capacitors 153 via the pulse compression circuit 150. At this point in time, the peaking capacitors 153 are quickly charged to a high voltage level. The pulse-shaped high voltage is then quickly applied from the charger 141 and the peaking capacitors 153 to the electrode 134b via the current introducing terminal 157. Note that the timing at which the high voltage is applied to the space between the preliminary ionization inner electrode 183 and the preliminary ionization outer electrode 185 is slightly earlier than the timing at which the high voltage is applied to the space between the electrode 134a and the electrode 134b. When the high voltage is applied to the space between the preliminary ionization inner electrode 183 and the preliminary ionization outer electrode 185, corona discharge occurs in the vicinity of the dielectric pipe 181 and the end of the preliminary ionization outer electrode 185, and ultraviolet light is radiated. When the laser gas between the electrodes 134a and 134b is irradiated with the ultraviolet light, the laser gas between the electrodes 134a and 134b is preliminarily ionized. After the preliminary ionization, when the high voltage is applied to the space between the electrodes 134a and 134b as described above, primary discharge occurs between the electrodes 134a and 134b.

The primary discharge excites the laser medium contained in the laser gas between the electrode 134a and the electrode 134b, and when the laser medium returns to the ground state, the laser medium emits light. This light resonates between the grating 145c and the output coupling mirror 147, and the light is amplified whenever passing through the discharge space in the internal space of the discharge chamber 131, resulting in laser oscillation. Part of the resonating laser light passes as the pulse laser light through the output coupling mirror 147 and travels to the beam splitter 163.

Part of the laser light having traveled to the beam splitter 163 is reflected off the beam splitter 163 and received by the photosensor 165. The photosensor 165 measures the energy E of the received laser light and outputs the signal representing the energy E to the laser processor 190. The laser processor 190 controls the charging voltage in such a way that the difference AE between the energy E and the target energy Et falls within the allowable range, and after the difference AE falls within the allowable range, the laser processor 190 transmits the reception preparation completion signal, which indicates that the laser processor 190 is ready to receive the light emission trigger Tr, to the exposure processor 230.

Upon reception of the reception preparation completion signal, the exposure processor 230 transmits the light emission trigger Tr to the laser processor 190. When the laser processor 190 opens the shutter 170 in synchronization with the reception of the light emission trigger Tr, the laser light having passed through the shutter 170 enters the exposure apparatus 200. The laser light is, for example, pulse laser light having the center wavelength of 193 nm.

### 2.3 Problems

As described above, the metal seal 310a includes the straight sections 351a and the curved sections 352a. The curved sections 352a of the metal seal 310a tend to be unlikely to collapse in the pressing direction of the pressing force produced by the chamber body 131M and the electrically insulating plate 135 than the straight sections 351a. When the curved sections 352a of the metal seal 310a do not collapse sufficiently, there is a concern that the distance between the electrically insulating plate 135 and the chamber body 131M differs from a design value. There is therefore a concern that the distance between the electrode 134b fixed to the electrically insulating plate 135 and the electrode 134a disposed on the electrode holder 137 differs from a design value. Furthermore, the metal seal 310b includes the straight sections 351b and the curved sections 352b, as described above. The curved sections 352b of the metal seal 310b tend to be unlikely to collapse in the pressing direction of the pressing force produced by the upper chamber 131a and the lower chamber 131b than the straight sections 351b. When the curved sections 352b of the metal seal 310b do not collapse sufficiently, there is a concern that the distance between the upper chamber 131a and the lower chamber 131b differs from a design value, and that the relative position of the laser light output from the discharge chamber 131 with respect to the lower chamber 131b differs from a design value. Therefore, when neither the curved sections 352a nor the curved sections 352b sufficiently collapse, the laser light having a different design value may be output.

To address the problem described above, a discharge chamber 131 capable of outputting laser light as designed is shown by way of example in the embodiments below.

### 3. Description of First Embodiment

A discharge chamber 131 that is a discharge chamber for a gas laser apparatus according to a first embodiment will next be described. Note that the same configurations as those described above have the same reference characters, and duplicate description of the same configurations will be omitted unless otherwise particularly described. In some drawings, some members may be omitted or simplified in some cases for clarity.

### 3.1 Configuration

FIG. 8 is a cross-sectional view of a metal seal 310a used in the discharge chamber 131 according to the present embodiment taken along the longitudinal direction of the metal seal 310a. The metal seal 310a in the present embodiment differs from the metal seal 310a in Comparative Example in that when the curved sections 352a are made straight, the winding interval of the wire constituting the coil spring 320 in the curved sections 352a is greater than the winding interval of the wire in the straight sections 351a. Therefore, in the metal seal 310a in the present embodiment, the curved sections 352a, when assumed to be made straight, have a spring constant in the radial direction smaller than the spring constant of the straight sections 351a in the radial direction. In the metal seal 310a in the present embodiment, which is pressed so as to collapse in the radial direction, which is a particular direction, the curved sections 352a, when assumed to be made straight, have a spring constant in the pressing direction smaller than the spring constant of the straight sections 351a in the pressing direction. The spring constant is the force of the spring acting on an object divided by the amount of deformation of the object. Therefore, when the curved sections 352a are made straight, and a predetermined force is applied to the metal seal in the pressing direction, the curved sections 352a more greatly collapse than the straight sections 351a. In the present example, in the straight sections 351a, the adjacent wire portions constituting the coil spring 320 are in contact with each other without any gap therebetween, and when the curved sections 352a are made straight, a gap is formed between the adjacent wire portions in the curved sections 352a.

In the state shown in FIG. 5, the spring constant of the curved sections 352a of the metal seal 310a in the pressing direction is preferably equal to the spring constant of the straight sections 351a of the metal seal 310a in the pressing direction.

A variation of the configuration in which the curved sections 352a, when assumed to be made straight, have a spring constant in the pressing direction smaller than the spring constant of the straight sections 351a in the pressing direction will next be described.

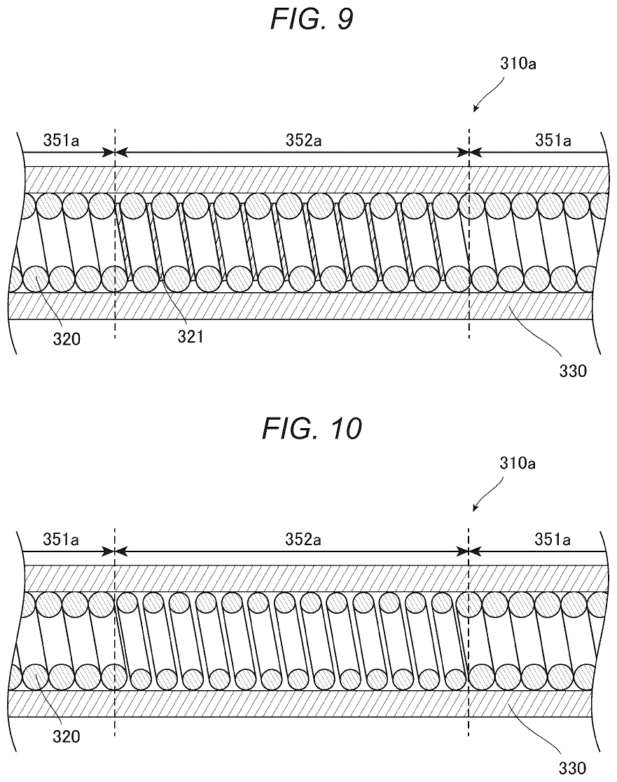

FIG. 9 is a cross-sectional view of the metal seal 310a in a first variation taken along the longitudinal direction. In the present variation, the winding interval of the wire constituting the coil spring 320 in the curved sections 352a is greater than the winding interval of the wire in the straight sections 351a, and retainers 321 are disposed between the wire portions in the curved sections 352a, as shown in FIG. 9. The retainers 321 are each a plate-shaped member, and has a size in the in-plane direction smaller than the diameter of the coil spring 320. A gap is therefore created between the retainers 321 and the outer shell 330 in the pressing direction in which the metal seal 310a is pressed. Hindrance of the collapse of the metal seal 310a due to the retainers 321 is therefore avoided. The material of the retainers 321 may, for example, be resin. Placing the retainers 321 between the wire portions can suppress a decrease in the winding interval of the wire in the curved sections 352a, and can therefore suppress an increase in the spring constant of the curved sections 352a in the pressing direction.

FIG. 10 is a cross-sectional view of the metal seal 310a in a second variation taken along the longitudinal direction. In the present variation, the thickness of the wire constituting the coil spring 320 in the curved sections 352a is smaller than the thickness of the wire in the straight sections 351a, as shown in FIG. 10. Note in the present example that the winding interval of the wire in the curved sections 352a and the winding interval of the wire in the straight sections 351a are equal to each other. The winding interval of the wire in the curved sections 352a may, however, be greater or smaller than the winding interval of the wire in the straight sections 351a. In the present example, the spring constant of the curved sections 352a in the pressing direction can be reduced irrespective of the winding interval of the wire.

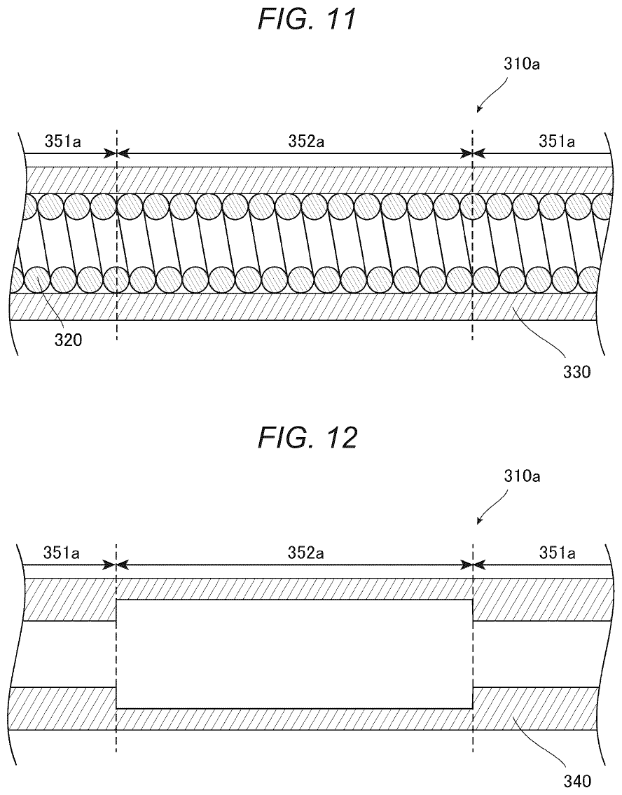

FIG. 11 is a cross-sectional view of the metal seal 310a in a third variation taken along the longitudinal direction. In the present variation, the thickness and the winding interval of the wire constituting the coil spring 320 in the curved sections 352a are equal to the thickness and the winding interval of the wire in the straight sections 351a, as shown in FIG. 11. In the present variation, however, the straight sections 351a and the curved sections 352a differs from each other in the material of the wire, and the Young's modulus of the wire constituting the coil spring 320 in the curved sections 352a is smaller than the Young's modulus of the wire in the straight sections 351a. The material of the wire in the curved sections 352a may, for example, be stainless steel, and the material of the wire in the straight sections 351a may, for example, be steel. At the boundaries between the straight sections 351a and the curved sections 352a, the wires made of different materials are connected to each other, for example, by welding.

Note that as long as the curved sections 352a, when assumed to be made straight, have a spring constant in the pressing direction smaller than the spring constant of the straight sections 351a in the pressing direction, the configurations of the metal seal 310a described with reference to FIGS. 8 to 11 may be combined with each other as appropriate.

The metal seal 310b used in the discharge chamber 131 in the present embodiment has substantially the same configuration as the metal seal 310a. Therefore, also in the metal seal 310b, the curved sections 352b, when assumed to be made straight, have a spring constant in the pressing direction smaller than the spring constant of the straight sections 351b in the pressing direction.

### 3.2 Effects and Advantages

In the discharge chamber 131 according to the present embodiment, the curved sections 352a and 352b of the metal seals 310a and 310b, when assumed to be made straight, have spring constants in the pressing direction smaller than the spring constants of the straight sections 351a and 351b of the metal seals 310a and 310b in the pressing direction. Therefore, as compared with the case where the curved sections 352a and 352b, when assumed to be made straight, have spring constants in the pressing direction equal to the spring constants of the straight sections 351a and 351b in the pressing direction, the metal seals 310a and 310b are likely to collapse at the curved sections 352a and 352b. The situation in which insufficient collapse of the metal seal 310a in the curved sections 352a causes the distance between the electrically insulating plate 135 and the chamber body 131M to differ from the design value is therefore avoided. The situation in which the distance between the electrodes 134b and 134a differs from the design value is therefore avoided. Furthermore, the situation in which insufficient collapse of the metal seal 310b in the curved sections 352b causes distance between the upper chamber 131a and the lower chamber 131b to differ from the design value is avoided, and the situation in which the relative position of the laser light output from the discharge chamber 131 with respect to the lower chamber 131b differs from the design value is avoided. The discharge chamber 131 according to the present embodiment can therefore output the laser light as designed.

### 4. Description of Second Embodiment

A discharge chamber 131 that is a discharge chamber for a gas laser apparatus according to a second embodiment will next be described. Note that the same configurations as those described above have the same reference characters, and duplicate description of the same configurations will be omitted unless otherwise particularly described.

### 4.1 Configuration

FIG. 12 is a cross-sectional view of a metal seal 310a used in the discharge chamber 131 according to the present embodiment taken along the longitudinal direction thereof. The metal seal 310a in the present embodiment differs from the metal seal 310a in the first embodiment in that the former is configured with a metal tube 340, as shown in FIG. 12. In the present embodiment, the wall thickness of the metal tube 340 in the curved sections 352a is smaller than the wall thickness of the metal tube 340 in the straight sections 351a. The diameter of the inner circumferential surface of the metal tube 340 in the curved sections 352a is therefore greater than the diameter of the inner circumferential surface of the metal tube 340 in the straight sections 351a. Therefore, in the metal seal 310a in the present embodiment, the curved sections 352a, when assumed to be made straight, have a spring constant in the radial direction smaller than the spring constant of the straight sections 351a in the radial direction. As a result, in the metal seal 310a in the present embodiment, the curved sections 352a, when assumed to be made straight, have a spring constant in the pressing direction smaller than the spring constant of the straight sections 351a in the pressing direction. The spring constant is the force of the spring acting on an object divided by the amount of deformation of the object, as described above. Therefore, in the present embodiment as well, when the curved sections 352a are made straight and a predetermined force is applied in the pressing direction, the curved sections 352a collapse by a greater amount than the straight sections 351a.

Note in the present embodiment that the straight sections 351a and the curved sections 352a may differ from each other in the material of which the metal tube 340 is made, and the Young's modulus of the material of which the metal tube 340 in the curved sections 352a is made may be smaller than the Young's modulus of the material of which the metal tube 340 in the straight sections 351a is made, as in the third variation of the first embodiment. In this case, the material of the metal tube 340 in the curved sections 352a may, for example, be stainless steel, and the material of the metal tube 340 in the straight sections 351a may, for example, be steel. At the boundaries between the straight sections 351a and the curved sections 352a, the metal tubes made of different materials are connected to each other, for example, by welding.

Also in the present embodiment, in the state shown in FIG. 5, the spring constant of the curved sections 352a of the metal seal 310a in the pressing direction is preferably equal to the spring constant of the straight sections 351a of the metal seal 310a in the pressing direction. Also in the present embodiment, the metal seal 310b has substantially the same configuration as the metal seal 310a. Also in the metal seal 310b in the present embodiment, the curved sections 352b, when assumed to be made straight, have a spring constant in the pressing direction smaller than the spring constant of the straight sections 351b in the pressing direction.

### 4.2 Effects and Advantages

The discharge chamber 131 according to the present embodiment can also output the laser light as designed, as in the first embodiment.

Note that the wall thickness of the metal tube 340 may be fixed through the straight sections 351a and the curved sections 352a, and that the Young's modulus of the material of which the metal tube 340 in the curved sections 352a is made may be smaller than the Young's modulus of the material of which the metal tube 340 in the straight sections 351a is made, unlike the present embodiment.

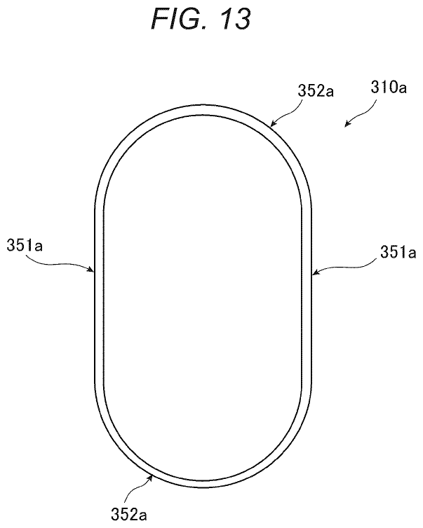

The embodiments of the present disclosure have been described above by way of example, and the present disclosure can be changed as appropriate. For example, as long as the curved sections 352a, when assumed to be made straight, have a spring constant in the pressing direction smaller than the spring constant of the straight sections 351a in the pressing direction, the configurations of the metal seals 310a and 310b may differ from those in the embodiments described above. In the embodiments described above, the metal seals 310a and 310b each have a substantially quadrangular shape. However, the metal seals 310a and 310b may not each have a quadrangular shape as long as the metal seal 310a includes the straight sections 351a and the curved sections 352a and the metal seal 310b includes the straight sections 351b and the curved sections 352b. A variation in which the metal seals 310a and 310b each have a shape other than a quadrangular shape will be described. FIG. 13 shows another variation of the metal seal 310a. The metal seal 310a has the shape of a racetrack including straight sections 351a and curved sections 352a, as shown in FIG. 13. The metal seal 310b may also have the shape of a racetrack, although not particularly shown.

The metal seals 310a and 310b may not have substantially the same configuration. Specifically, for example, the metal seal 310a may have the configuration in any of the embodiments described above, and the metal seal 310b may have a configuration different from those in the embodiments described above.

As the first and second chamber parts, the upper chamber 131a and the lower chamber 131b are presented by way of example, and the chamber body 131M and the electrically insulating plate 135 are also presented by way of example. The first and second chamber parts may instead be other parts that are combined with each other to enclose at least a portion of the internal space of the discharge chamber 131.

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious for those skilled in the art that embodiments of the present disclosure would be appropriately combined. The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A discharge chamber for a gas laser apparatus, the discharge chamber having an internal space in which a pair of discharge electrodes facing each other with a spacing therebetween are disposed and which encapsulates a laser gas, the discharge chamber comprising:
a first chamber part and a second chamber part combined with each other to enclose at least a portion of the internal space; and
a metal seal including a straight section and a curved section, disposed between the first chamber part and the second chamber part, and pressed by the first chamber part and the second chamber part to seal a gap between the first chamber part and the second chamber part,
the curved section of the metal seal, when assumed to be made straight, having a spring constant in a pressing direction smaller than a spring constant of the straight section of the metal seal in the pressing direction.

2. The discharge chamber for a gas laser apparatus according to claim 1, wherein
the metal seal includes a metal outer shell, and
a coil spring surrounded by the outer shell.

3. The discharge chamber for a gas laser apparatus according to claim 2, wherein
a winding interval of a wire constituting the coil spring in the curved section is greater than the winding interval of the wire in the straight section.

4. The discharge chamber for a gas laser apparatus according to claim 3, wherein
retainers are disposed between portions of the wire in the curved section.

5. The discharge chamber for a gas laser apparatus according to claim 4, wherein
the retainers are made of resin.

6. The discharge chamber for a gas laser apparatus according to claim 2, wherein
a thickness of a wire constituting the coil spring in the curved section is smaller than the thickness of the wire in the straight section.

7. The discharge chamber for a gas laser apparatus according to claim 2, wherein
a Young's modulus of a wire constituting the coil spring in the curved section is smaller than the Young's modulus of the wire in the straight section.

8. The discharge chamber for a gas laser apparatus according to claim 7, wherein
the wire in the curved section is made of stainless steel, and
the wire in the straight section is made of steel.

9. The discharge chamber for a gas laser apparatus according to claim 1, wherein
the metal seal is configured with a metal tube, and
a wall thickness of the metal tube in the curved section is smaller than the wall thickness of the metal tube in the straight section.

10. The discharge chamber for a gas laser apparatus according to claim 1, wherein
a spring constant of the metal seal in the curved section in a pressing direction is equal to a spring constant of the metal seal in the straight section in the pressing direction.

11. The discharge chamber for a gas laser apparatus according to claim 1, wherein
the first chamber part is an upper chamber constituting at least a portion of an upper side of the discharge chamber for a gas laser apparatus, and the second chamber part is a lower chamber constituting at least a portion of a lower side of the discharge chamber for a gas laser apparatus.

12. The discharge chamber for a gas laser apparatus according to claim 1, wherein
the first chamber part is a chamber body that constitutes a body of the discharge chamber for a gas laser apparatus and has an opening at an upper portion of the chamber body, and the second chamber part is a lid that closes the opening.

13. The discharge chamber for a gas laser apparatus according to claim 12, wherein
the lid is an insulating plate to which one of the discharge electrodes is fixed.

14. An electronic device manufacturing method comprising:
generating laser light by using a gas laser apparatus including a discharge chamber;
outputting the laser light to an exposure apparatus; and
exposing a photosensitive substrate to the laser light in the exposure apparatus to manufacture electronic devices,
the discharge chamber having an internal space in which a pair of discharge electrodes facing each other with a spacing therebetween are disposed and which encapsulates a laser gas, the discharge chamber including
a first chamber part and a second chamber part combined with each other to enclose at least a portion of the internal space, and
a metal seal including a straight section and a curved section, disposed between the first chamber part and the second chamber part, and pressed by the first chamber part and the second chamber part to seal a gap between the first chamber part and the second chamber part,
the curved section of the metal seal, when assumed to be made straight, having a spring constant in a pressing direction smaller than a spring constant of the straight section of the metal seal in the pressing direction.
